(19) United States
(12) Patent Application Publication
(10) Pub. No.: US 2017/0273496 A1
(43) Pub. Date: Sep. 28, 2017

(54) GRATING APPARATUS AND BEVERAGE PREPARATION APPARATUS

(71) Applicant: Sharp Kabushiki Kaisha, Sakai City, Osaka (JP)

(72) Inventors: Kazuya KITATANI, Sakai City, Osaka (JP); Hidekazu SHIMA, Sakai City, Osaka (JP)

(73) Assignee: Sharp Kabushiki Kaisha, Sakai City, Osaka (JP)

(21) Appl. No.: 15/505,680

(22) PCT Filed: Jan. 29, 2016
(86) PCT No.: PCT/JP2016/052703

§ 371 Date: Feb. 22, 2017

(30) Foreign Application Priority Data
Mar. 2, 2015 (JP) 2015-040451

(51) Int. Cl. A47J 31/00; B02C 7/18; A47J 31/44; A47J 42/12; A23F 3/18; A47J 31/40

(52) U.S. Cl. CPC A47J 31/002; A23F 3/18; A47J 31/40; A47J 31/44; A47J 42/12; B02C 7/18; A47J 31/00

(57) ABSTRACT

A grating apparatus grates an object to be grated, and includes an upper mill including an upper mill grinding surface and an opening portion in a center of the upper mill grinding surface, a lower mill located below the upper mill and including a lower mill grinding surface abutting on the upper mill grinding surface, and a core at least partially located in the opening portion. The core includes a plate-shaped portion which rotates, and an engagement portion engaged with an object to be grated is provided in a peripheral end surface of the plate-shaped portion.

### TECHNICAL FIELD

The present invention relates to a grating apparatus grating an object to be grated such as tea leaves and a beverage preparation apparatus including the same.

### BACKGROUND ART

A grating apparatus including a mill as means for grating an object to be grated such as tea leaves and cereals has conventionally been used. The grating apparatus obtains powders by finely grating an object to be grated between an upper mill and a lower mill constituting the mill. For example, Japanese Patent Laying-Open No. 9-248471 (PTD 1) discloses such a grating apparatus.

The grating apparatus disclosed in PTD 1 is constructed such that an upper mill rotates with respect to a lower mill and a material supply apparatus supplying powders grated in advance between the upper mill and the lower mill is provided above the upper mill. The material supply apparatus includes a hopper, a cylinder communicating with the hopper, supply means for supplying an object to be grated between the upper mill and the lower mill from the cylinder, and a screw rotatably provided in the cylinder for grating the object to be grated between the screw and the cylinder.

By introducing tea leaves as the object to be grated into the hopper and rotating the screw, the tea leaves are sheared and finely grated by the screw and the cylinder while the tea leaves are gradually sent downward by the screw. By supplying the finely grated tea leaves between the upper mill and the lower mill, tea leaves can finely be grated efficiently in a short period of time by the upper mill and the lower mill.

### CITATION LIST

### Patent Document

### PTD 1: Japanese Patent Laying-Open No. 9-248471

### SUMMARY OF INVENTION

### Technical Problem

In the grating apparatus described in PTD 1, however, tea leaves longer than an interval between cut portions provided in the screw may remain as leaning against a periphery of the screw. In this case, since tea leaves located on an outer side of such tea leaves are not pulled into the screw either, tea leaves which remain in the hopper may increase.

Therefore, when no measures are provided on a screw side or a hopper side, tea leaves cannot be sent to a mill in spite of introduction of tea leaves into the hopper.

The present invention was made in view of the problems as above, and an object of the present invention is to provide a grating apparatus capable of smoothly pulling an object to be grated in between a lower mill and an upper mill and a beverage preparation apparatus including the same.

### Solution to Problem

A grating apparatus based on a first aspect of the present invention grates an object to be grated, and includes an upper mill including an upper mill grinding surface and an opening portion in a center of the upper mill grinding surface, a lower mill located below the upper mill and including a lower mill grinding surface abutting on the upper mill grinding surface, and a core at least partially located in the opening portion. The core includes a plate-shaped portion which rotates. An engagement portion engaged with the object to be grated is provided in a peripheral end surface of the plate-shaped portion.

In the grating apparatus based on the first aspect of the present invention, the engagement portion may include a notch portion provided in the peripheral end surface of the plate-shaped portion.

In the grating apparatus based on the first aspect of the present invention, preferably, the notch portion has an end surface intersecting with a tangent line at a contact point portion provided in a periphery of the plate-shaped portion and is in a shape opening forward in a direction of rotation when viewed from the end surface.

In the grating apparatus based on the first aspect of the present invention, the engagement portion may include a projecting portion provided to project radially outward from the peripheral end surface of the plate-shaped portion.

A grating apparatus based on a second aspect of the present invention grates an object to be grated, and includes a cylindrical hopper in which the object to be grated is introduced, an upper mill located below the hopper and including an upper mill grinding surface and an opening portion in a center of the upper mill grinding surface, a lower mill located below the upper mill and including a lower mill grinding surface abutting on the upper mill grinding surface, and a core at least partially located in the opening portion. The hopper includes a rib projecting from an inner circumferential surface toward the core. The rib has an upper end located at a height not higher than an upper end of the core located in the hopper.

In the grating apparatus based on the second aspect of the present invention, a plurality of ribs may be provided and the plurality of ribs may be provided as being displaced in a vertical direction.

In the grating apparatus based on the second aspect of the present invention, the core preferably includes a plate-shaped portion which rotates, and an engagement portion engaged with the object to be grated is preferably provided in a peripheral end surface of the plate-shaped portion.

In the grating apparatus based on the second aspect of the present invention, the engagement portion is preferably provided between the plurality of ribs in a vertical direction.

A beverage preparation apparatus based on the present invention includes the grating apparatus described in any portion above, a tank storing a liquid, and an agitation tank to which powders obtained by the grating apparatus and the liquid are supplied and in which the powders and the liquid are mixed.

### Advantageous Effects of Invention

According to the present invention, a grating apparatus capable of smoothly pulling an object to be grated in between a lower mill and an upper mill and a beverage preparation apparatus including the same can be provided.

### BRIEF DESCRIPTION OF DRAWINGS

FIG. 1 is an overall perspective view of a beverage preparation apparatus according to a first embodiment.

FIG. 2 is a cross-sectional view along the line II-II shown in FIG. 1.

FIG. 3 is an overall perspective view showing a component of the beverage preparation apparatus shown in FIG. 1.

FIG. 4 shows a first preparation flow showing discharge of tea using the beverage preparation apparatus shown in FIG. 1.

FIG. 5 shows a second preparation flow showing discharge of tea using the beverage preparation apparatus shown in FIG. 1.

FIG. 6 shows a third preparation flow showing discharge of tea using the beverage preparation apparatus shown in FIG. 1.

FIG. 7 is a perspective view of an internal structure of the beverage preparation apparatus shown in FIG. 1.

FIG. 8 is a perspective view of a milling unit provided in the beverage preparation apparatus shown in FIG. 1.

FIG. 9 is an exploded perspective view of the milling unit shown in FIG. 8.

FIG. 10 is a vertical cross-sectional view of the milling unit shown in FIG. 8.

FIG. 11 is an exploded perspective view of an agitation unit provided in the beverage preparation apparatus shown in FIG. 1.

FIG. 12 is a vertical cross-sectional view of the agitation unit shown in FIG. 11.

FIG. 13 is a perspective view from above, of an assembly diagram of a core, a lower mill, and an upper mill according to the first embodiment.

FIG. 14 is a perspective view from below, of the assembly diagram of the core, the lower mill, and the upper mill shown in FIG. 13.

FIG. 15 is an exploded perspective view from above, of the core, the lower mill, and the upper mill shown in FIG. 13.

FIG. 16 is a perspective view of the core according to the first embodiment.

FIG. 17 is a front view of the core shown in FIG. 16.

FIG. 18 is a side view of the core shown in FIG. 16.

FIG. 19 is a diagram showing tea leaves in a hopper in grating tea leaves with the milling unit according to the first embodiment.

FIG. 20 is a perspective view of a core according to a second embodiment.

FIG. 21 is a front view of the core shown in FIG. 20.

FIG. 22 is a side view of the core shown in FIG. 20.

FIG. 23 is a diagram showing tea leaves in the hopper in grating tea leaves with a milling unit according to the second embodiment.

FIG. 24 is a perspective view of a core according to a third embodiment.

FIG. 25 is a front view of the core shown in FIG. 24.

FIG. 26 is a side view of the core shown in FIG. 24.

FIG. 27 is a partial vertical cross-sectional view of a milling unit in a comparative example.

FIG. 28 is a view from above of tea leaves in the hopper in grating tea leaves with the milling unit in the comparative example.

FIG. 29 is a cross-sectional view along the line XXIX-XXIX shown in FIG. 28.

FIG. 30 is a partial vertical cross-sectional view of a milling unit according to a fourth embodiment.

FIG. 31 is a cross-sectional view showing tea leaves in the hopper in grating tea leaves with the milling unit according to the fourth embodiment.

FIG. 32 is a diagram showing the inside of the hopper in a milling unit according to a fifth embodiment.

FIG. 33 is a diagram showing one example of tea leaves sheared in the hopper shown in FIG. 32.

FIG. 34 is a diagram showing another example of tea leaves sheared in the hopper shown in FIG. 32.

### DESCRIPTION OF EMBODIMENTS

Embodiments of the present invention will be described below in detail with reference to the drawings. In the embodiments shown below, the same or common elements have the same reference numerals allotted in the drawings and description thereof will not be repeated.

### First Embodiment

In the present embodiment, though a case that tea leaves are used as an object to be grated and tea is prepared as a beverage will be described by way of example, the object to be grated is not limited to tea leaves, but the embodiment can also be applied to preparation of a beverage with cereals, dried goods, and other objects to be grated. Hereinafter, tea leaves mean a solid state before grating, tea leaf powders mean grated tea leaves, and tea means a beverage obtained by agitating (mixing) tea leaf powders and hot water.

(Beverage Preparation Apparatus 1)

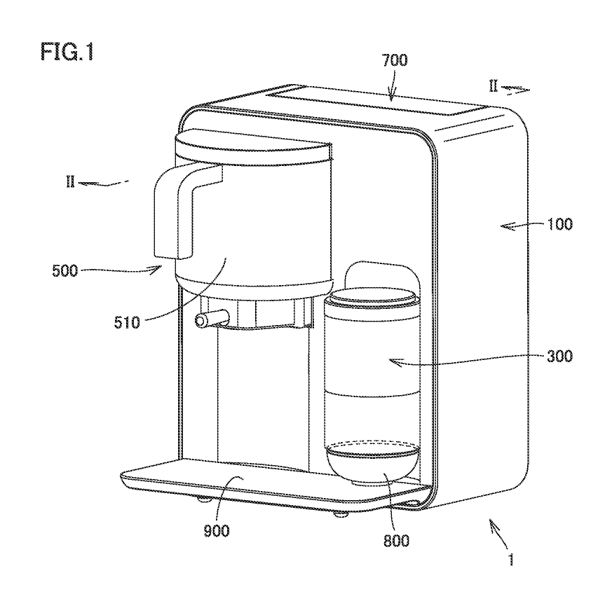

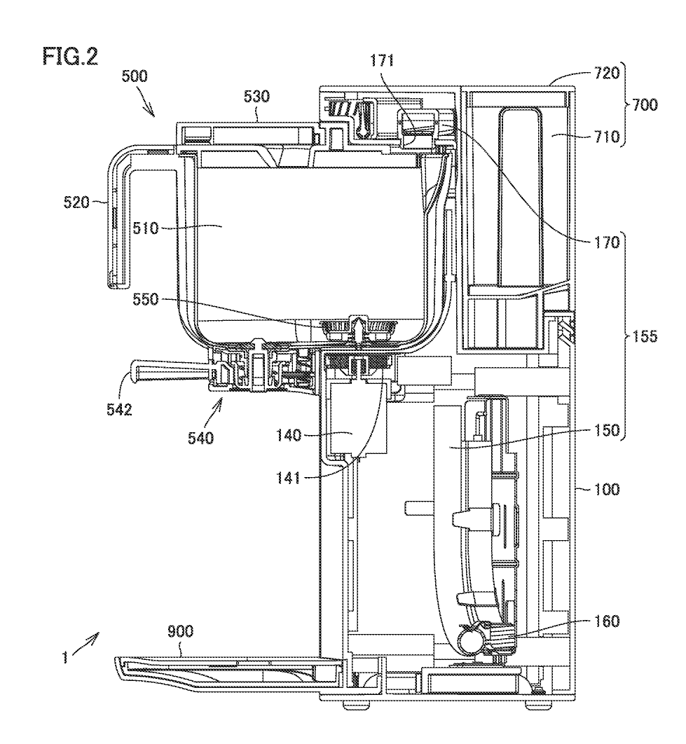

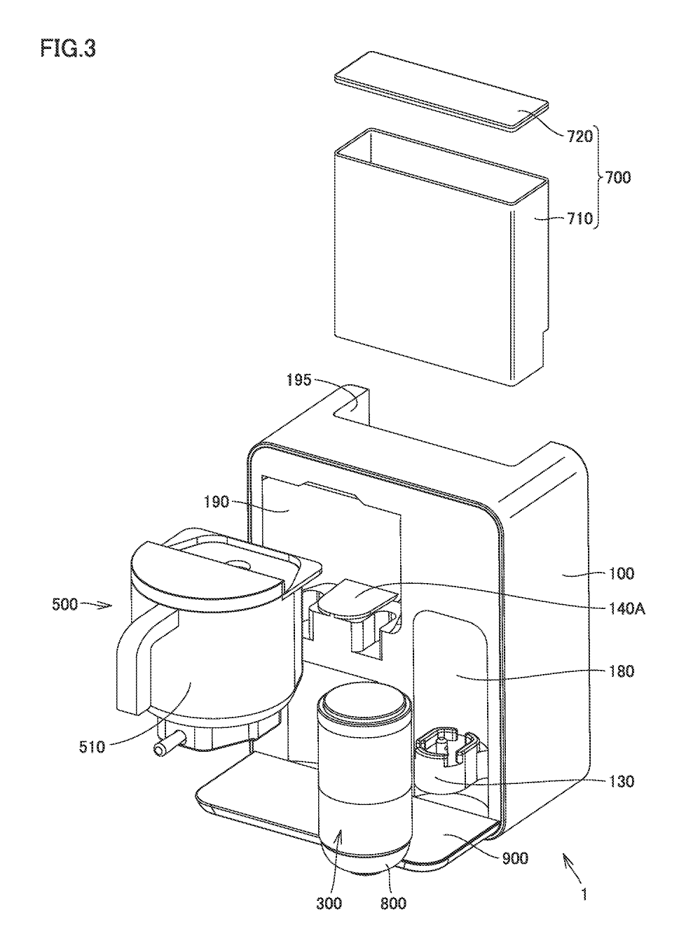

A beverage preparation apparatus 1 in the present embodiment will be described with reference to FIGS. 1 to 3. FIG. 1 is an overall perspective view of beverage preparation apparatus 1 according to the present embodiment, FIG. 2 is a cross-sectional view along the line II-II in FIG. 1, and FIG. 3 is an overall perspective view of a schematic component of beverage preparation apparatus 1 shown in FIG. 1.

As shown in FIGS. 1 to 3, beverage preparation apparatus 1 uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100, a milling unit 300 as a grating apparatus, an agitation unit 500, a liquid storage tank 700, a liquid supply path 155 (see FIG. 2), a tea leaf powder tray 800, and a placement base 900. Placement base 900 is provided to protrude forward on a front side in a lower portion of apparatus main body 100 and a cup (not shown) and tea leaf powder tray 800 can be placed thereon. Tea leaf powder tray 800 is provided such that a user can hold and move the tray.

(Milling Unit 300)

Milling unit 300 is removably attached to a milling unit attachment portion 180 provided on a front surface side of apparatus main body 100. A milling driving force coupling mechanism 130 is provided in milling unit attachment portion 180 so as to protrude forward. Milling unit 300 is removably attached to this milling driving force coupling mechanism 130. Milling unit 300 obtains driving force for milling tea leaves representing an object to be grated by being coupled to milling driving force coupling mechanism 130.

Tea leaves introduced from an upper portion of milling unit 300 into milling unit 300 are finely grated in milling unit 300. The grated tea leaves are dropped and collected as tea leaf powders on tea leaf powder tray 800 placed below milling unit 300. A detailed structure of milling unit 300 will be described later with reference to FIGS. 8 to 10.

(Liquid Storage Tank 700)

Liquid storage tank 700 is removably attached to a liquid storage tank attachment portion 195 provided on an upper surface side of apparatus main body 100. Liquid storage tank 700 includes a tank main body 710 having an opening in an upper surface and a lid portion 720 closing the opening in the upper surface of tank main body 710. Liquid storage tank 700 stores such a liquid as water which is introduced from the outside after lid portion 720 is removed.

(Liquid Supply Path 155)

Liquid supply path 155 is accommodated in apparatus main body 100. Liquid supply path 155 is connected to liquid storage tank 700 (see FIG. 7). Liquid supply path 155 is provided with a supply port 171 on a side opposite to a side where liquid storage tank 700 is connected. Liquid supply path 155 includes a hot water supply pipe 150 and a hot water supply nozzle 170. Hot water supply pipe 150 has one end side connected to liquid storage tank 700 and the other end side connected to hot water supply nozzle 170. A liquid introduced from liquid storage tank 700 into liquid supply path 155 is supplied to agitation unit 500 through hot water supply pipe 150 and hot water supply nozzle 170.

(Agitation Unit 500)

Agitation unit 500 includes an agitation blade 550 for agitating a liquid and powders and an agitation tank 510 accommodating agitation blade 550. Agitation tank 510 is removably attached to an agitation tank attachment portion 190 provided on the front surface side of apparatus main body 100. Agitation tank 510 is attached to agitation tank attachment portion 190 such that a part of agitation tank 510 protrudes from a front surface of apparatus main body 100 along a direction of normal to the front surface.

An agitation motor contactless table 140A is provided in agitation tank attachment portion 190. Agitation unit 500 is placed on agitation motor contactless table 140A. Agitation blade 550 provided in agitation unit 500 is rotated by an agitation motor unit 140 and a permanent magnet 141 coupled thereto. Agitation motor unit 140 and permanent magnet 141 are accommodated in apparatus main body 100 so as to be located below agitation motor contactless table 140A. Agitation motor unit 140 rotationally drives agitation blade 550.

Hot water supply nozzle 170 is provided above agitation tank attachment portion 190 of apparatus main body 100. In apparatus main body 100, a temperature of water in hot water supply pipe 150 is raised to a prescribed temperature and hot water is supplied from hot water supply nozzle 170 into agitation tank 510. Hot water prepared in apparatus main body 100 and tea leaf powders obtained by milling unit 300 are introduced into agitation tank 510, and hot water and tea leaf powders are agitated by agitation blade 550 in agitation tank 510. Tea is thus prepared in agitation tank 510.

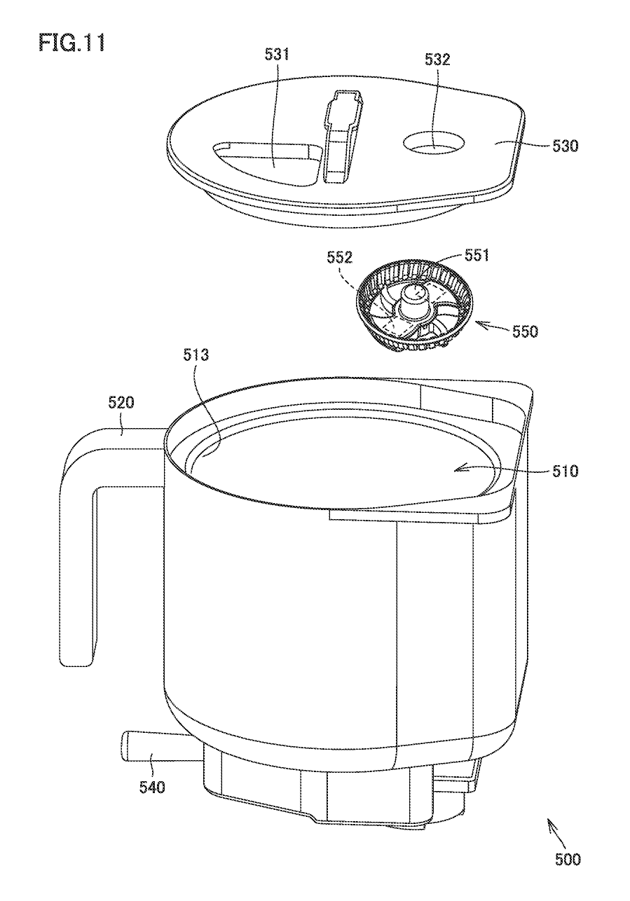

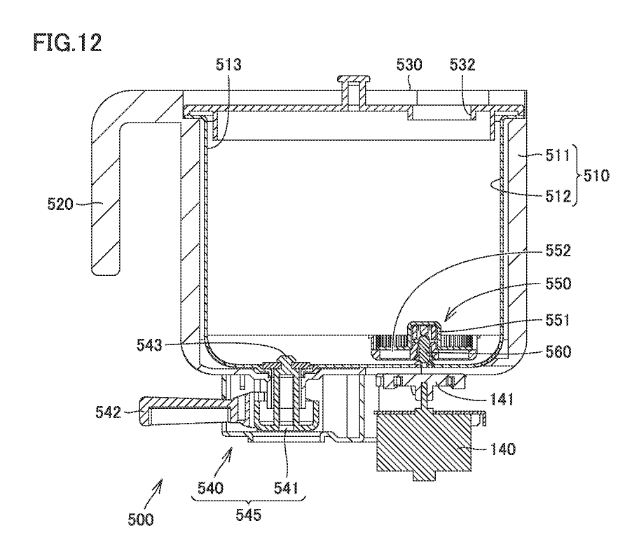

Tea prepared in agitation unit 500 can be poured into a cup (not shown) placed on placement base 900 by operating an operation lever 542 of a discharge port opening and closing mechanism 540 provided below agitation unit 500. A detailed structure of agitation unit 500 will be described later with reference to FIGS. 11 and 12.

(Flow of Preparation of Tea (Beverage))

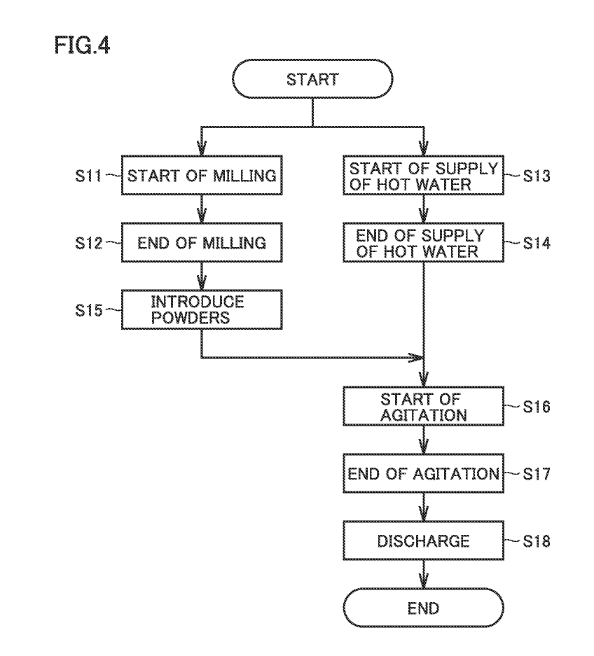

A flow of preparation of tea (beverage) with the use of beverage preparation apparatus 1 will now be described with reference to FIGS. 4 to 6. FIGS. 4 to 6 show first to third preparation flows showing discharge of tea using the beverage preparation apparatus, respectively. A prescribed amount of tea leaves is introduced into milling unit 300 and a prescribed amount of water is stored in liquid storage tank 700.

(First Preparation Flow)

A first preparation flow will be described with reference to FIG. 4. This first preparation flow is a flow in which grating of tea leaves in milling unit 300 and supply of hot water from apparatus main body 100 to agitation unit 500 are simultaneously carried out.

In beverage preparation apparatus 1, milling of tea leaves by milling unit 300 in a step 11 and supply of hot water from apparatus main body 100 to agitation unit 500 in a step 13 are simultaneously started. Then, milling of tea leaves by milling unit 300 ends in a step 12, and supply of hot water from apparatus main body 100 to agitation unit 500 ends in a step 14.

In a step 15, tea leaf powders obtained in step 12 are introduced into agitation unit 500 by a user.

Then, in a step 16, agitation of the tea leaf powders and hot water in agitation unit 500 is started. In a step 17, agitation of the tea leaf powders and hot water in agitation unit 500 ends. In a step 18, tea is discharged into the cup placed on placement base 900 as the user operates operation lever 542 of discharge port opening and closing mechanism 540 provided below agitation unit 500. According to the present flow, since milling of tea leaves and supply of hot water are simultaneously performed, a tea beverage can efficiently be prepared in a short period of time.

(Second Preparation Flow)

A second preparation flow will be described with reference to FIG. 5. This second preparation flow is a flow in which hot water is supplied from apparatus main body 100 to agitation unit 500 after tea leaves are grated in milling unit 300.

In beverage preparation apparatus 1, in a step 21, milling of tea leaves by milling unit 300 is started. In a step 22, milling of tea leaves by milling unit 300 ends. In a step 23, tea leaf powders obtained in step 22 are introduced into agitation unit 500 by a user.

In a step 24, supply of hot water from apparatus main body 100 to agitation unit 500 is started. In a step 25, supply of hot water from apparatus main body 100 to agitation unit 500 ends.

Then, in a step 26, agitation of the tea leaf powders and hot water in agitation unit 500 is started. In a step 27, agitation of the tea leaf powders and hot water in agitation unit 500 ends. In a step 28, tea is discharged into the cup placed on placement base 900 as the user operates operation lever 542 of discharge port opening and closing mechanism 540 provided below agitation unit 500. According to the present flow, since hot water is supplied after tea leaves are milled, lowering in temperature of hot water can be suppressed.

(Third Preparation Flow)

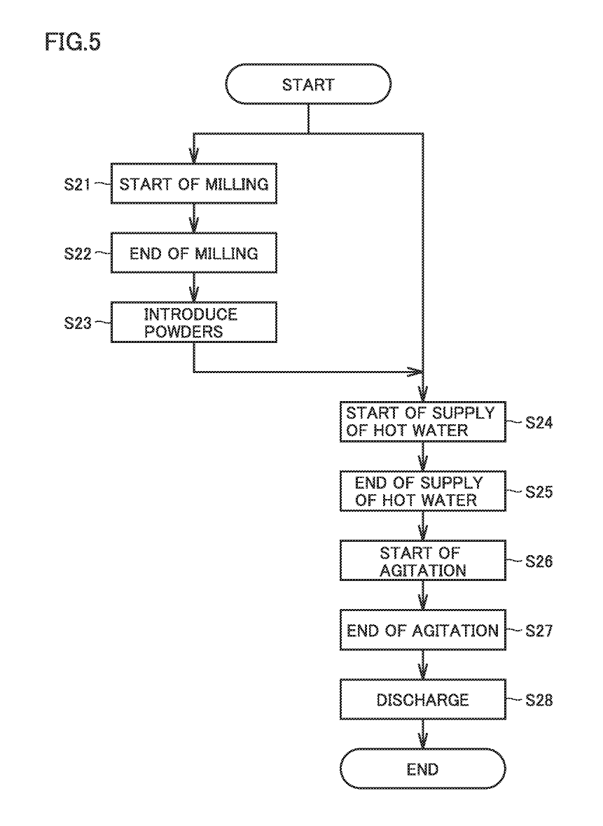

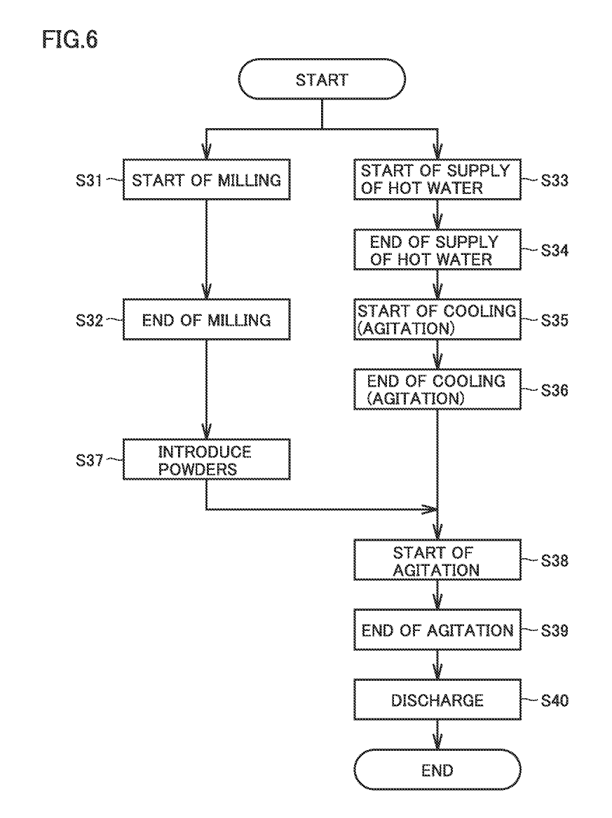

A third preparation flow will be described with reference to FIG. 6. This third preparation flow includes a step of cooling hot water by agitation in agitation unit 500.

In beverage preparation apparatus 1, milling of tea leaves by milling unit 300 in a step 31 and supply of hot water from apparatus main body 100 to agitation unit 500 in a step 33 are simultaneously started. In a step 34, supply of hot water from apparatus main body 100 to agitation unit 500 ends.

Then, in a step 32, milling of tea leaves by milling unit 300 ends, and in a step 35, cooling by agitation of hot water supply is started in agitation unit 500. In a step 36, cooling by agitation of hot water supply in agitation unit 500 ends.

Though hot water is cooled by rotating agitation blade 550 in steps 35 and 36, cooling is not limited to this method. For example, a cooling portion may separately be provided in beverage preparation apparatus 1 for cooling of agitation tank 510. Cooling by the cooling portion is desirably, for example, cooling by sending of air by a fan or cooling with water.

In a step 37, the tea leaf powders obtained in step 32 are introduced into agitation unit 500 by a user.

Then, in a step 38, agitation of the tea leaf powders and hot water in agitation unit 500 is started. In a step 39, agitation of the tea leaf powders and hot water in agitation unit 500 ends. In a step 40, tea is discharged into the cup placed on placement base 900 as the user operates operation lever 542 of discharge port opening and closing mechanism 540 provided below agitation unit 500. According to the present flow, a tea beverage can be prepared at an appropriate temperature from tea leaves suitable for hot water at a relatively low temperature, such as gyokuro.

(Internal Structure of Apparatus Main Body 100)

An internal structure of apparatus main body 100 will now be described with reference to FIG. 7. FIG. 7 is a perspective view showing the internal structure of beverage preparation apparatus 1 shown in FIG. 1. In apparatus main body 100 of beverage preparation apparatus 1, a control portion 110 including a printed circuit board on which electronic components are mounted is arranged on a front surface side of liquid storage tank 700. Based on input of a start signal by a user, the flow for preparation of tea is executed by control portion 110.

A milling motor unit 120 for providing driving force to milling unit 300 is arranged at a position below control portion 110. Milling driving force coupling mechanism 130 provided to protrude forward for transmitting driving force of milling motor unit 120 to milling unit 300 is provided at a position below milling motor unit 120.

To a bottom surface of liquid storage tank 700, one end of hot water supply pipe 150 extending once downward from the bottom surface and then extending upward in a U shape is coupled. Hot water supply nozzle 170 for pouring hot water into agitation tank 510 of agitation unit 500 is coupled to an upper end portion of hot water supply pipe 150. A U-shaped heater 160 for heating water which passes through hot water supply pipe 150 is attached to an intermediate region of hot water supply pipe 150.

(Structure of Milling Unit 300)

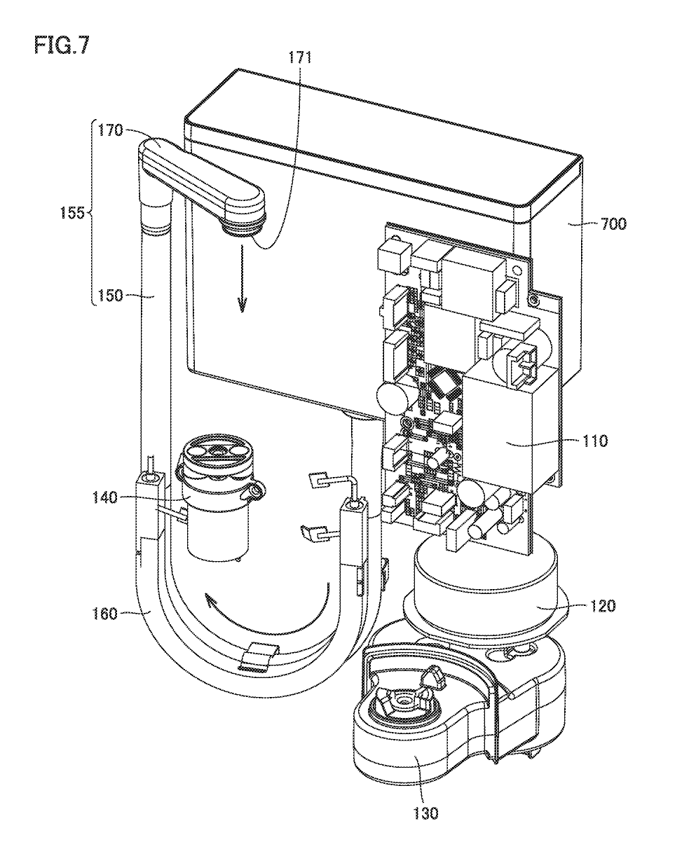

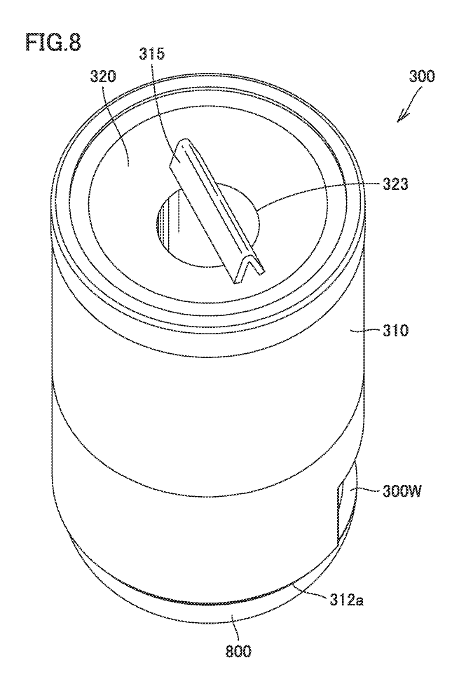

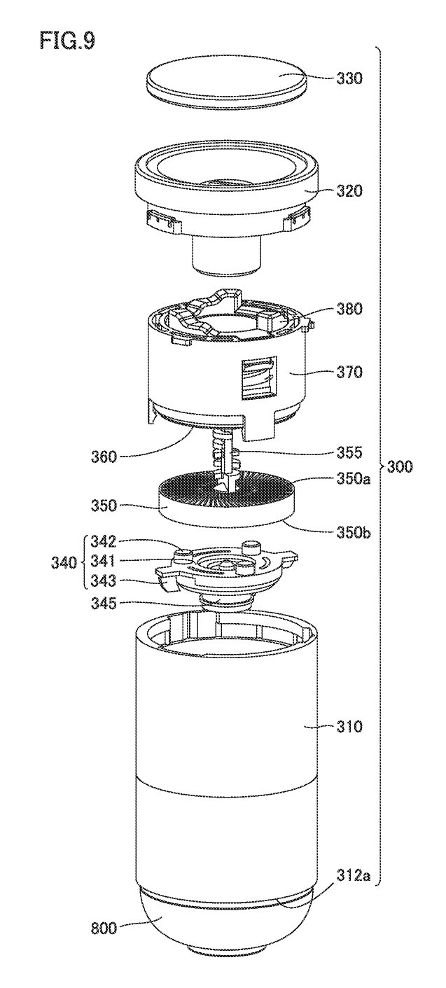

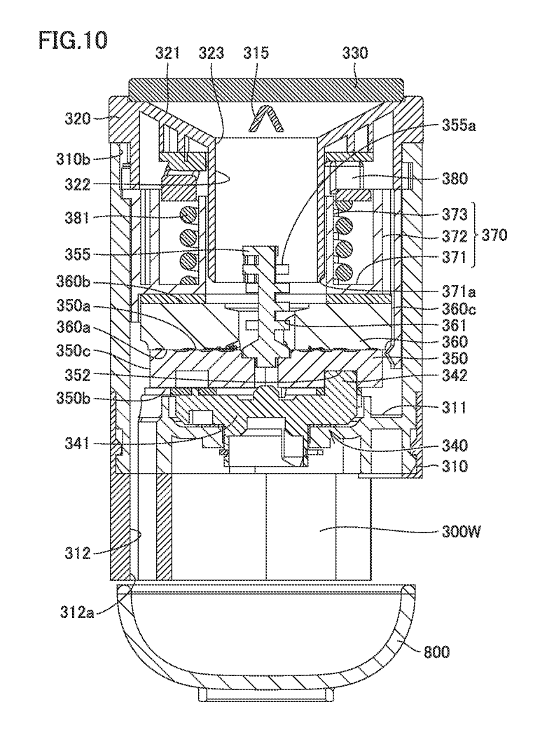

A structure of milling unit 300 will now be described with reference to FIGS. 8 to 10. FIG. 8 is a perspective view of milling unit 300 provided in the beverage preparation apparatus shown in FIG. 1, FIG. 9 is an exploded perspective view of milling unit 300 shown in FIG. 8, and FIG. 10 is a vertical cross-sectional view of milling unit 300 shown in FIG. 8.

Milling unit 300 has a milling case 310 having a cylindrical shape as a whole, and a window for coupling 300W in which milling driving force coupling mechanism 130 is inserted is provided in a side surface below. A storage portion 311 (see FIG. 10) for storing tea leaf powders produced by an upper mill 360 and a lower mill 350 and a discharge path 312 communicating with storage portion 311 are provided in milling case 310. A discharge outlet 312a for discharging tea leaf powders into tea leaf powder tray 800 is provided at a lower end portion of discharge path 312 which is a lowermost portion of milling case 310. Discharge outlet 312a is provided below an opening portion 513 of a thermally insulated tank 512 (see FIG. 12) which will be described later. Entry through discharge outlet 312a, of steam resulting from hot water supplied into thermally insulated tank 512 can thus be prevented.

Milling unit 300 includes upper mill 360 and lower mill 350 which grate an object to be grated and a lower mill support portion 340 to which lower mill 350 is attached. In milling case 310, lower mill support portion 340, lower mill 350, and upper mill 360 are successively provided from below.

Lower mill support portion 340 supports lower mill 350 from a side opposite to a side where upper mill 360 is located (a lower side of lower mill 350). Lower mill support portion 340 has a substantially columnar main body portion 341, an engagement protrusion portion 342, and a powder scraping portion 343. A milling shaft 345 is provided on a lower surface of main body portion 341 and extends downward. Milling shaft 345 is coupled to milling driving force coupling mechanism 130. Lower mill support portion 340 is thus rotatable while it supports lower mill 350.

Engagement protrusion portion 342 is provided on an upper surface of main body portion 341 and protrudes upward. Engagement protrusion portion 342 is a site for locking lower mill 350. Powder scraping portion 343 is provided around a circumferential portion of main body portion 341. Powder scraping portion 343 scrapes off tea leaf powders stored in storage portion 311 and transports the tea leaf powders to discharge path 312 as lower mill support portion 340 rotates.

Lower mill 350 includes a lower mill grinding surface 350a arranged to be opposed to an upper mill grinding surface 360a of upper mill 360, a main surface 350b located opposite to lower mill grinding main surface 350a, and a circumferential surface 350c connecting lower mill grinding surface 350a and main surface 350b to each other.

An engagement recess portion 352 is provided in main surface 350b of lower mill 350. Engagement recess portion 352 is provided at a position corresponding to engagement protrusion portion 342 of lower mill support portion 340 and locked by engagement protrusion portion 342. Lower mill 350 rotates in coordination with lower mill support portion 340. A core 355 extending upward along a core of a rotation axis is provided in a central portion of lower mill 350.

Core 355 is provided to pass through an opening portion 361 in upper mill 360 which will be described later. Core 355 has a helically provided helical blade 355a.

Upper mill 360 includes upper mill grinding surface 360a arranged to be opposed to lower mill grinding surface 350a of lower mill 350, a main surface 360b located opposite to upper mill grinding surface 360a, and a circumferential surface 360c connecting upper mill grinding surface 360a and main surface 360b to each other. Upper mill 360 includes opening portion 361 provided in a center of upper mill grinding surface 360a. Upper mill 360 is held by an upper mill holding member 370 arranged above the upper mill.

Upper mill holding member 370 includes a bottom surface portion 371 provided with a hole portion 371a, an outer cylindrical portion 372 erected upward from a circumference of bottom surface portion 371, and an inner cylindrical portion 373 erected upward from a circumference of hole portion 371a. Hole portion 371a is provided to communicate with opening portion 361 in upper mill 360. A spring 381 pressing upper mill 360 downward and a spring holding member 380 are accommodated in between outer cylindrical portion 372 and inner cylindrical portion 373. Spring 381 adjusts a grating pressure applied between upper mill 360 and lower mill 350.

A hopper 320 for supplying an object to be grated in between upper mill 360 and lower mill 350 is attached to a side of an upper end opening portion 310b of milling case 310. Hopper 320 is in a shape of a funnel. Hopper 320 has a diameter-increasing portion 321 and a cylindrical portion 322.

Diameter-increasing portion 321 is provided such that an inner diameter thereof increases in an upward direction. Cylindrical portion 322 is provided to be connected to a lower end of diameter-increasing portion 321. Cylindrical portion 322 is inserted in inner cylindrical portion 373.

A safety rib 315 is provided in diameter-increasing portion 321 as straddling cylindrical portion 322. Safety rib 315 is linearly provided. Though safety rib 315 has a substantially triangular cross-section at an angle acute in an upward direction, limitation to this shape is not intended.

Cylindrical portion 322 has an opening portion 323 on an upper end side. Opening portion 323 functions as an inlet for an object to be grated through which an object to be grated is introduced into cylindrical portion 322. As an inner circumferential surface of diameter-increasing portion 321 is inclined, tea leaves in diameter-increasing portion 321 are guided toward the inlet for the object to be grated.

In grating tea leaves, hopper 320 is preferably covered with a cover portion 330. Thus, after tea leaves are introduced into the inlet for the object to be grated, entry of a foreign matter into milling unit 300 can be prevented and scattering of grated tea leaves can be prevented. When tea leaves are to be introduced, cover portion 330 is removed from hopper 320.

Tea leaves introduced into the inlet for the object to be grated are accommodated in a space defined by the upper surface of upper mill 360 exposed through upper mill holding member 370 and an inner circumferential surface of cylindrical portion 322. Tea leaves accommodated in the space are guided by helical blade 355a which rotates with rotation of lower mill 350 and guided between upper mill 360 and lower mill 350.

Tea leaves sent in between upper mill 360 and lower mill 350 are grated and fall downward in a form of tea leaf powders from a circumference of upper mill 360 and lower mill 350. Some of fallen tea leaf powders is discharged through discharge path 312 into tea leaf powder tray 800 from discharge outlet 312a. Other fallen tea leaf powders are stored in storage portion 311. Tea leaf powders in storage portion 311 are transported into discharge path 312 by powder scraping portion 343 which rotates with rotation of lower mill portion support portion 340 and discharged from discharge outlet 312a into tea leaf powder tray 800.

(Structure of Agitation Unit 500)

A structure of agitation unit 500 will now be described with reference to FIGS. 11 and 12. FIG. 11 is an exploded perspective view of agitation unit 500 provided in beverage preparation apparatus 1 shown in FIG. 1 and FIG. 12 is a vertical cross-sectional view of agitation unit 500 shown in FIG. 11.

Agitation unit 500 is in a shape of a container of which upper surface opens and includes agitation tank 510, agitation blade 550, an agitation cover 530, and discharge port opening and closing mechanism 540. Agitation tank 510 includes an exterior holder 511 made of a resin and thermally insulated tank 512 held by exterior holder 511. An integrally resin molded grip 520 is provided in exterior holder 511. Thermally insulated tank 512 has a cylindrical shape with bottom and has an opening portion 513 which opens upward.

Agitation cover 530 closes opening portion 513 so as to be able to open and close opening portion 513. Agitation cover 530 is provided with a powder inlet 531 for introducing tea leaf powders grated by milling unit 300 and a hot water supply inlet 532 through which hot water formed in apparatus main body 100 is poured from hot water supply nozzle 170. Hot water supply inlet 532 is provided at a position corresponding to supply port 171 of hot water supply nozzle 170.

Powder inlet 531 and hot water supply inlet 532 communicate with opening portion 513. Tea leaf powders introduced from moved tea leaf powder tray 800 to powder inlet 531 are introduced into thermally insulated tank 512 through opening portion 513. Hot water poured through hot water supply inlet 532 from hot water supply nozzle 170 is supplied into thermally insulated tank 512 through opening portion 513.

Agitation blade 550 is placed on a bottom portion of agitation tank 510. A rotation shaft 560 extending upward is provided on the bottom portion of agitation tank 510, and a cylindrical core 551 of agitation blade 550 is inserted in this rotation shaft 560.

A permanent magnet 552 is embedded in agitation blade 550. In agitation motor contactless table 140A, permanent magnet 552 embedded in agitation blade 550 and permanent magnet 141 provided on a side of agitation motor unit 140 are magnetically coupled in a contactless state, so that rotational driving force of agitation motor unit 140 is transmitted to agitation blade 550.

Agitation blade 550 can be modified as appropriate so long as an agitation member having an agitation element in an outer circumferential portion is provided. A winding portion made of a wire in a toroidal shape or an impeller can be adopted as the agitation element.

Agitation tank 510 further includes a discharge portion 545 for discharging a prepared beverage. Discharge portion 545 is provided in agitation tank 510 in a portion protruding from apparatus main body 100. Discharge portion 545 includes a discharge port 541 provided in the bottom portion of agitation tank 510 and discharge port opening and closing mechanism 540 opening and closing discharge port 541. Discharge port 541 is a portion for discharging tea prepared by agitation of tea leaf powders and hot water by agitation blade 550.

Discharge port opening and closing mechanism 540 includes an opening and closing nozzle 543 inserted into discharge port 541 so as to be able to open and close discharge port 541 and operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541 and thus tea in agitation tank 510 is poured into a cup (not shown) placed on placement base 900.

Though an example in which agitation tank 510 is constituted of exterior holder 511 and thermally insulated tank 512 in agitation unit 500 described above has been described by way of example, limitation thereto is not intended and the agitation tank may consist of thermally insulated tank 512. Instead of thermally insulated tank 512, a container which is not thermally insulated but is heat resistant may be employed.

Though an example in which agitation tank 510 is removably attached to apparatus main body 100 in agitation unit 500 described above has been described by way of example, limitation thereto is not intended and the agitation tank may be fixed to apparatus main body 100 so long as powders and hot water can be introduced therein and the inside of agitation tank 510 can be cleaned. In this case, a prepared beverage is extracted to the outside from the discharge portion provided in agitation tank 510.

(Detailed Structure of Grating Mechanism)

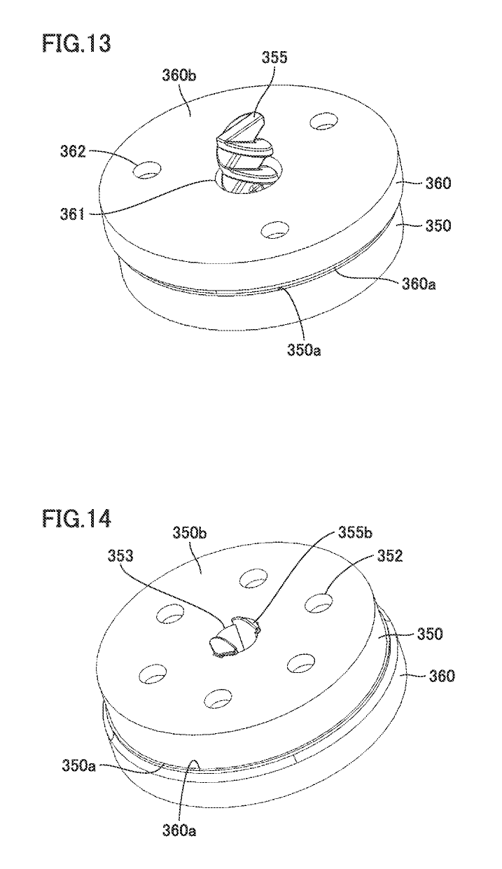

A detailed structure of a grating mechanism including lower mill 350, core 355, and upper mill 360 will now be described with reference to FIGS. 13 to 15. FIG. 13 is a perspective view from above, of an assembly diagram of core 355, lower mill 350, and upper mill 360 according to the present embodiment. FIG. 14 is a perspective view from below, of the assembly diagram of core 355, lower mill 350, and upper mill 360 shown in FIG. 13. FIG. 15 is an exploded perspective view from above, of core 355, lower mill 350, and upper mill 360 shown in FIG. 13.

As shown in FIG. 13, lower mill 350 and upper mill 360 are arranged such that lower mill grinding surface 350a of lower mill 350 and upper mill grinding surface 360a of upper mill 360 are in contact with each other. Core 355 is provided in lower mill 350 and protrudes upward from upper mill 360 through opening portion 361 in upper mill 360.

As shown in FIG. 14, core 355 is fixed to lower mill 350 by being engaged with main surface 350b of lower mill 350 owing to a tab portion 355b.

As shown in FIG. 15, core 355 is fixed at a central portion of lower mill 350. A plurality of grating grooves 351 extending from the central portion toward the circumference are provided in lower mill grinding surface 350a of lower mill 350. The plurality of grating grooves 351 are provided, for example, to extend along an equiangular spiral. The plurality of grating grooves 351 may be such that linear grooves extending from an inner circumferential side toward an outer circumference are radially provided. Similarly, a plurality of grating grooves are provided also in upper mill grinding surface 360a of upper mill 360.

Lower mill 350 and core 355 rotate in a direction shown with an arrow A with respect to upper mill 360. A hole portion 362 in which a rotation stop pin (not shown) is inserted is provided in upper mill grinding surface 360a of upper mill 360. While the rotation stop pin is inserted in hole portion 362, the upper mill is held by upper mill holding member 370 (see FIG. 10) described above. Thus, lower mill 350 can rotate while rotation of upper mill 360 is prevented. Lower mill 350 and upper mill 360 are made of alumina, and lower mill grinding surface 350a and upper mill grinding surface 360a have a diameter, for example, of approximately 50 mm.

(Core 355)

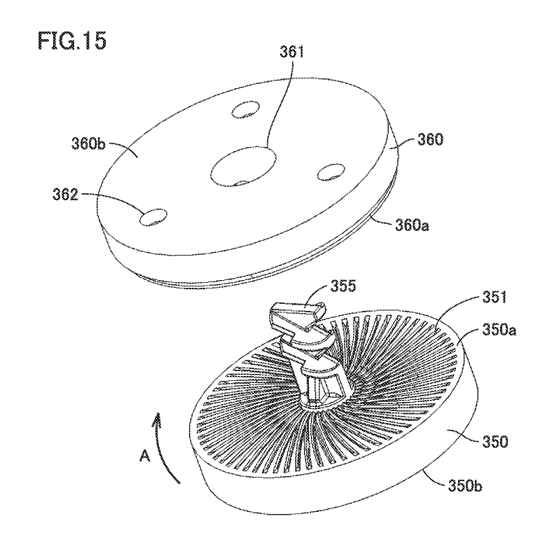

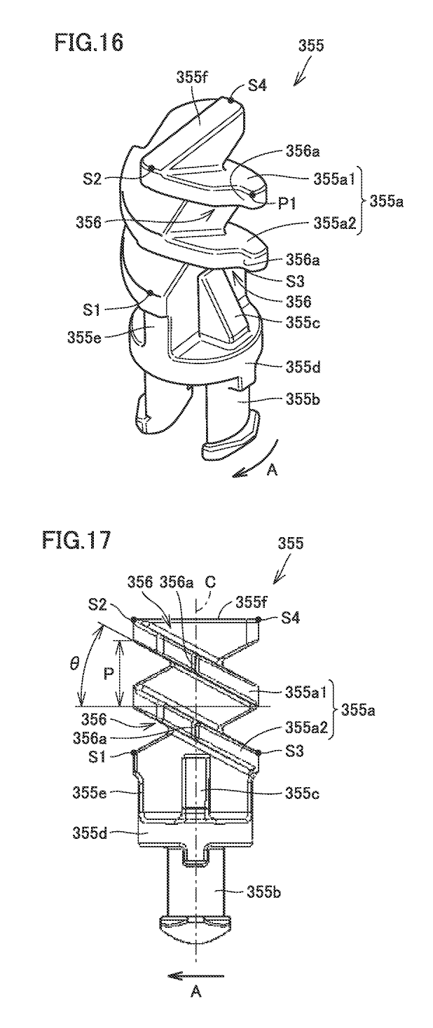

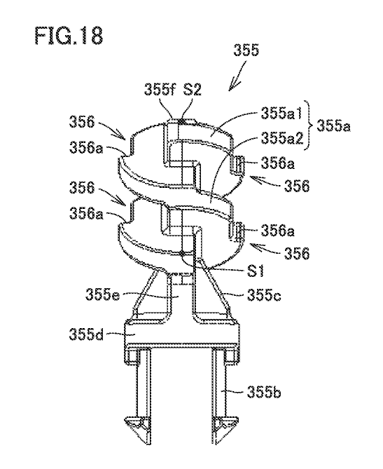

A shape of core 355 in the present embodiment will now be described with reference to FIGS. 16 to 18. FIG. 16 is a perspective view of core 355 according to the present embodiment. FIGS. 17 and 18 are a front view and a side view of core 355 shown in FIG. 16, respectively.

As shown in FIGS. 16 to 18, core 355 includes a helical blade 355a as a plate-shaped portion, tab portion 355b, a reinforcement rib 355c, a base portion 355d, and a shaft portion 355e.

Helical blade 355a is provided in a direction of left-hand thread opposite in direction of thread to a direction of right rotation (the direction shown with arrow A in the figure) of core 355. A notch portion 356 as an engagement portion engaged with tea leaves is provided in a peripheral end surface of helical blade 355a. Helical blade 355a is provided around shaft portion 355e.

Shaft portion 355e is provided to extend upward from the central portion of base portion 355d substantially in a disc shape. Shaft portion 355e is in a shape of a plate which passes linearly through the center of base portion 355d across a prescribed width when viewed in a direction of an axial line. A recess portion substantially in a shape of a triangular prism in accordance with inclination of helical blade 355a which will be described later is provided in a side surface of shaft portion 355e.

Helical blade 355a has a first helical blade portion 355a1 and a second helical blade portion 355a2. Helical blade 355a (first helical blade portion 355a1 and second helical blade portion 355a2) is provided to have a pitch P and an inclination θ. Pitch P and inclination θ are set approximately to P=6 mm and θ=40° in the present embodiment.

First helical blade portion 355a1 is provided to go around shaft portion 355e from a helix start point S1 to a helix end point S2. Similarly, second helical blade portion 355a2 is provided to go around shaft portion 355e from a helix start point S3 to a helix end point S4.

First helical blade portion 355a1 and second helical blade portion 355a2 are preferably provided such that the number of turns is 1 or smaller from an upper end of opening portion 361 in upper mill 360 to an upper end of core 355.

By setting the number of turns to 1 or smaller, in grating of tea leaves, a point where tea leaves leaning against helical blade 355a are supported (a portion of contact between tea leaves and a periphery of helical blade 355a) moves downward with rotation of core 355 and tea leaves can be tilted toward core 355. Since tea leaves tilted toward core 355 ride on an upper surface of helical blade 355a and are guided into opening portion 361 in upper mill 360, the tea leaves are likely to be pulled in between upper mill 360 and lower mill 350.

Helix start point S1 and helix start point S3 are provided at positions distant from base portion 355d in an upward direction by a prescribed distance. Helix start point S1 and helix start point S3 are provided at the same height position. Helix start point S3 is located at a position at 180 degrees around a central axis C from a position of helix start point S1.

Helix end point S2 and helix end point S4 are provided at the same height position. Helix end point S2 and helix end point S4 are connected to an upper surface 355f of core 355. Upper surface 355f of the core is in a planar shape intersecting with the direction of the axial line of core 355. Specifically, upper surface 355f is in a rectangular shape orthogonal to the direction of the axial line of core 355. Therefore, upper surface 355f defines the upper end of core 355.

When the upper end of core 355 is thus provided, tea leaves located above core 355 in grating of tea leaves ride on the upper surface of helical blade 355a projecting radially outward from upper surface 355f when viewed in the direction of the axial line of the core. Tea leaves which have ridden on the upper surface of helical blade 355a of core 355 move downward with rotation of helical blade 355a and are guided into opening portion 361 in upper mill 360, so that tea leaves are likely to be pulled in between upper mill 360 and lower mill 350.

Reinforcement rib 355c reinforces shaft portion 355e. Reinforcement rib 355c is provided on base portion 355d. Reinforcement rib 355c is provided at a position at 90 degrees around central axis C from each of helix start point S1 and helix start point S3. Reinforcement rib 355c is in a shape of a substantially right triangular prism of which inclined side surface portion faces upward. Reinforcement rib 355c is provided on the inner side of an outer diameter of helical blade 355a.

Tab portion 355b is provided opposite to a side where shaft portion 355e and helical blade 355a are located, with respect to base portion 355e. Tab portion 355b is provided to extend downward from base portion 355d. A part of base portion 355d and tab portion 355b are inserted in a through hole 353 (see FIG. 14) provided in the center of lower mill 350 and tab portion 355b is engaged with main surface 350b of lower mill 350, so that core 355 is fixed to lower mill 350.

A plurality of notch portions 356 are provided in first helical blade portion 355a1 and second helical blade portion 355a2. The plurality of notch portions 356 are provided in first helical blade portion 355a1 and second helical blade portion 355a2 in a portion located above and in first helical blade portion 355a1 and second helical blade portion 355a2 in a portion located below.

Specifically, the plurality of notch portions 356 are provided in first helical blade portion 355a1 and second helical blade portion 355a2 between helix start points S1 and S3 and respective portions halfway around from helix start points S1 and S3 and between the respective portions halfway around from helix start points S1 and S3 and helix end points S2 and S4. The plurality of notch portions 356 are provided in first helical blade portion 355a1 and second helical blade portion 355a2, for example, at a pitch of 180° in the direction of rotation.

Notch portion 356 provided in first helical blade portion 355a1 has an end surface 356a intersecting with a tangent line at a contact point portion P1 provided in the periphery of first helical blade portion 355a1 and is in a shape opening forward in the direction of rotation of core 355 when viewed from this end surface.

Notch portion 356 provided in second helical blade portion 355a2 is provided substantially similarly to notch portion 356 provided in first helical blade portion 355a1.

Tea leaves in hopper 320 in grating of tea leaves with milling unit 300 according to the present embodiment will be described with reference to FIG. 19. FIG. 19 is a diagram showing tea leaves in the hopper in grating tea leaves with the milling unit according to the present embodiment.

As shown in FIG. 19, for example, even when tea leaves longer than above-described pitch P of helical blade 355a remain in hopper 320 in a standing position, notch portion 356 is engaged with tea leaves during rotation of core 355.

As core 355 rotates in the direction of rotation while notch portion 356 is engaged with tea leaves T, positions of tea leaves T are lost. Specifically, tea leaves T are pushed forward in the direction of rotation by end surface 356a of notch portion 356 and tilted in a direction DR1.

Tea leaves T which have been tilted ride on the upper surface of helical blade 355a of core 355 and move downward with rotation of helical blade 355a. Tea leaves T move downward and are guided into opening portion 361 in upper mill 360 and pulled in between upper mill 360 and lower mill 350.

As set forth above, in milling unit 300 according to the present embodiment and beverage preparation apparatus 1 including the same, notch portion 356 provided in the peripheral end surface of helical blade 355a of core 355 is engaged with tea leaves so that positions of tea leaves T can be lost with rotation of core 355. Thus, tea leaves T longer than pitch P of helical blade 355a can be prevented from maintaining a state leaning against core 355 and retention of tea leaves in hopper 320 can be suppressed. Consequently, tea leaves can smoothly be pulled in between upper mill 360 and lower mill 350.

### Second Embodiment

(Core 355A)

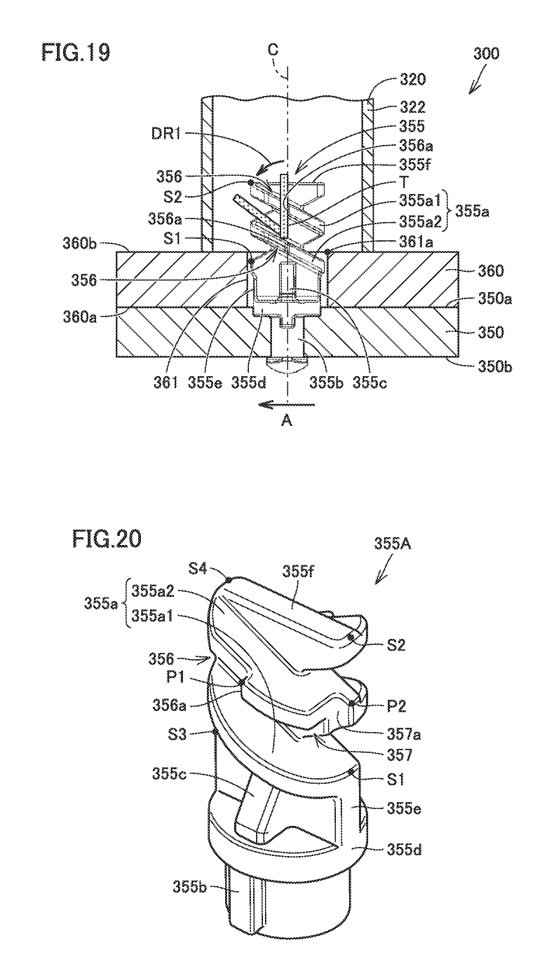

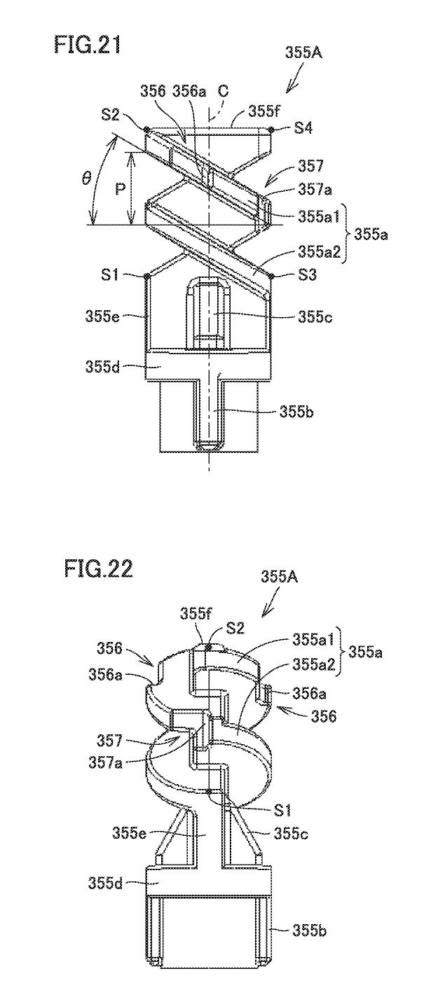

A core 355A according to the present embodiment will be described with reference to FIGS. 20 to 22. FIG. 20 is a perspective view of core 355A according to the present embodiment. FIGS. 21 and 22 are a front view and a side view of core 355A shown in FIG. 20, respectively.

As shown in FIGS. 20 to 22, core 355A according to the present embodiment is different from core 355 according to the first embodiment in position where a plurality of notch portions 356 and 357 are provided but substantially the same in other features.

The plurality of notch portions 356 and 357 provided in first helical blade portion 355a1 are provided at an interval along the direction of rotation of core 355A. For example, the plurality of notch portions 356 and 357 are provided at a pitch of 90° along the direction of rotation.

Notch portion 356 in first helical blade portion 355a1 is provided, for example, in a portion ¾ around from helix start point S1. Notch portion 357 in first helical blade portion 355a1 is provided, for example, in a portion halfway around from helix start point S1.

Notch portion 356 and notch portion 357 provided in first helical blade portion 355a1 have end surface 356a and an end surface 357a, respectively, which intersect with tangent lines at contact point portion P1 and a contact point portion P2 provided in the periphery of first helical blade portion 355a1, and are in a shape opening forward in the direction of rotation of core 355 when viewed from end surfaces 356a and 357a.

Notch portions 356 and 357 provided in second helical blade portion 355a2 are provided substantially similarly to notch portion 356 provided in first helical blade portion 355a1. Notch portion 356 in second helical blade portion 355a2 is provided, for example, in a portion ¾ around from helix start point S3. Notch portion 357 in second helical blade portion 355a2 is provided, for example, in a portion halfway around from helix start point S3.

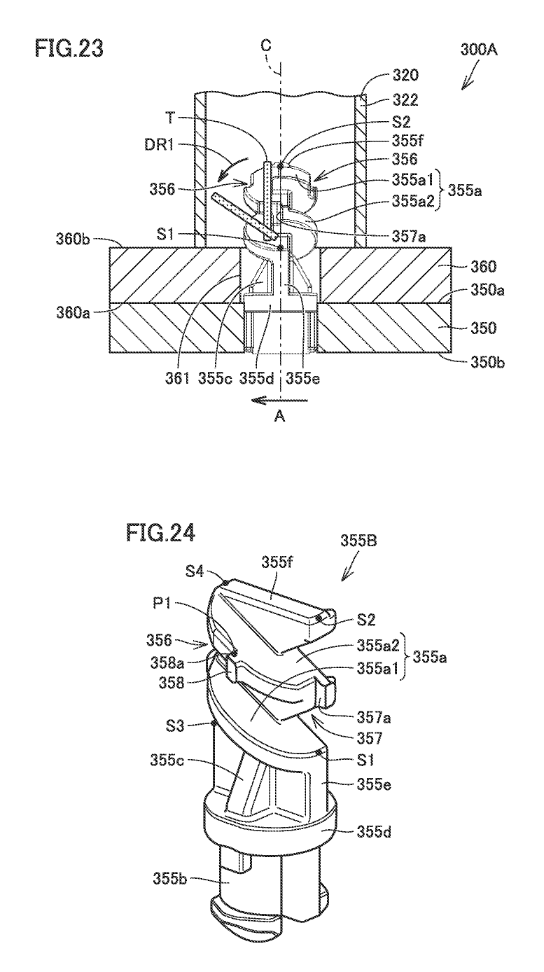

Tea leaves in hopper 320 in grating of tea leaves with a milling unit 300A according to the present embodiment will be described with reference to FIG. 23. FIG. 23 is a diagram showing tea leaves in the hopper in grating tea leaves with the milling unit according to the present embodiment.

As shown in FIG. 23, notch portions 356 and 357 are engaged with tea leaves T during rotation of core 355A also in the present embodiment. Thus, positions of tea leaves T in a standing state are lost by notch portions 356 and 357. Specifically, tea leaves T are pushed forward in the direction of rotation also by end surfaces 356a and 357a of respective notch portions 356 and 357, and tilted in direction DR1. Thus, tea leaves T ride on the upper surface of helical blade 355a of core 355A and more tea leaves T can smoothly be pulled in between upper mill 360 and lower mill 350.

As set forth above, with milling unit 300A according to the present embodiment and the beverage preparation apparatus including the same, notch portions 356 and 357 provided in the peripheral end surface of helical blade 355a of core 355A are engaged with tea leaves T so that positions of tea leaves T can be lost with rotation of core 355. Thus, tea leaves T longer than pitch P of helical blade 355a can be prevented from maintaining a state leaning against core 355A and retention of tea leaves in hopper 320 can be suppressed. Consequently, tea leaves can smoothly be pulled in between upper mill 360 and lower mill 350.

As the plurality of notch portions 356 and 357 are provided at an interval along the direction of rotation, load imposed on core 355A can be distributed in the circumferential direction. Thus, core 355A can be prevented from being broken.

### Third Embodiment

(Core 355B)

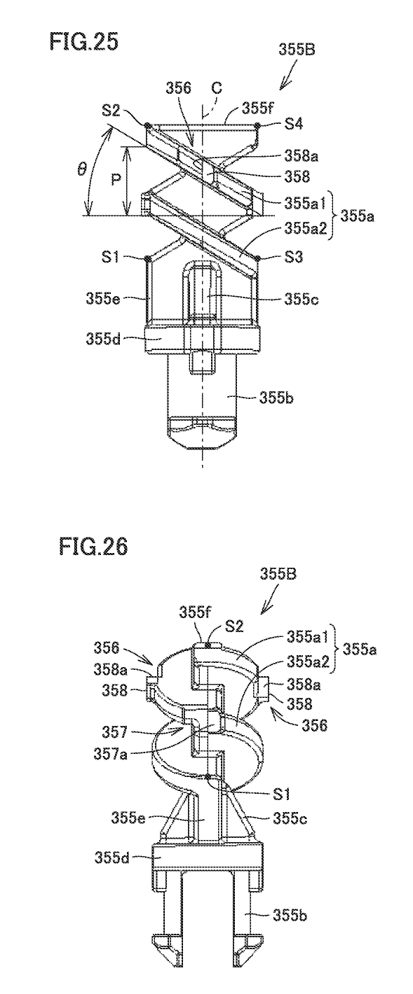

A core 355B according to the present embodiment will be described with reference to FIGS. 24 to 26. FIG. 24 is a perspective view of the core according to the present embodiment. FIGS. 25 and 26 are a front view and a side view of the core shown in FIG. 24, respectively.

As shown in FIGS. 24 to 26, core 355B according to the present embodiment is different form core 355 according to the first embodiment in including a protrusion portion 358 but substantially the same in other features.

Protrusion portion 358 is provided to protrude radially outward from the peripheral end surface of helical blade 355a. Protrusion portion 358 is provided in each of first helical blade portion 355a1 and second helical blade portion 355a2.

Protrusion portions 358 provided in first helical blade portion 355a1 and second helical blade portion 355a2 are provided between portions halfway around from helix start points S1 and S3 and helix end points S2 and S4, respectively. Protrusion portion 358 is provided, for example, in a portion ¾ around from each of helix start points S1 and S3.

Protrusion portion 358 is provided to enlarge end surface 356a of notch portion 356 radially outward. Protrusion portion 358 is provided such that an end surface 358a intersecting with a contact point portion provided in the periphery of each of first helical blade portion 355a1 and second helical blade portion 355a2 is formed.

Though an example in which both of notch portion 356 and protrusion portion 358 are provided has been described in the present embodiment by way of example, limitation thereto is not intended and only protrusion portion 358 may be provided.

With protrusion portion 358, for example, even when tea leaves longer than above-described pitch P of helical blade 355a remain in hopper 320 in a standing position, protrusion portion 358 serving as an engagement portion is engaged with tea leaves during rotation of core 355B.

As core 355B rotates in the direction of rotation while protrusion portion 358 is engaged with tea leaves, positions of the tea leaves are lost. Specifically, the tea leaves are pushed forward in the direction of rotation by end surface 358a of protrusion portion 358 and are tilted in direction DR1 (see FIGS. 22 and 23) as described above.

The tilted tea leaves ride on the upper surface of helical blade 355a of core 355B and move downward with rotation of helical blade 355a. Tea leaves move downward and are guided into opening portion 361 in upper mill 360 and pulled in between upper mill 360 and lower mill 350.

As set forth above, according to milling unit 300 according to the present embodiment and beverage preparation apparatus 1 including the same, protrusion portion 358 provided in the peripheral end surface of helical blade 355a of core 355B is engaged with tea leaves so that positions of tea leaves can be lost with rotation. Thus, tea leaves longer than pitch P of helical blade 355a can be prevented from maintaining a state leaning against core 355 and retention of tea leaves in hopper 320 can be suppressed. Consequently, tea leaves can smoothly be pulled in between upper mill 360 and lower mill 350.

When both of notch portion 356 and protrusion portion 358 are provided, an amount of tea leaves engaged with the engagement portion increases and hence more tea leaves can smoothly be pulled in between upper mill 360 and lower mill 350. Though an outermost geometry of the core is substantially annular when viewed form above in the present embodiment, limitation thereto is not intended, and such a shape that a distance from a central axis is different may be applicable. For example, in a case of an oval shape, tea leaves can be tilted and can be pulled in between the upper mill and the lower mill more smoothly than in the case of an annular shape even though no engagement portion is provided.

### Comparative Example

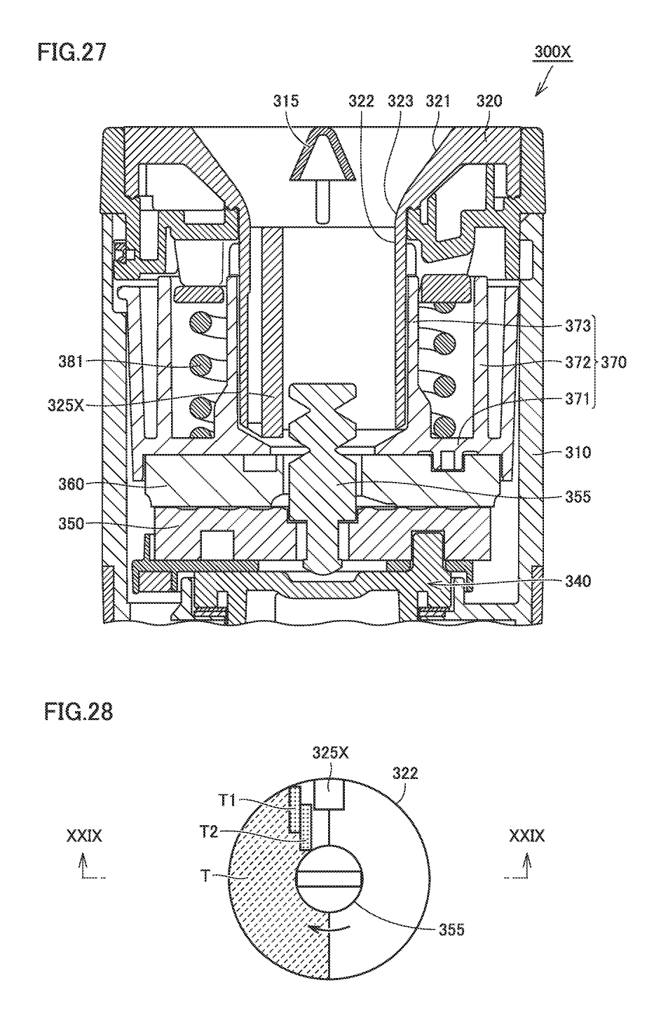

A milling unit 300X in a comparative example will be described with reference to FIG. 27. FIG. 27 is a partial vertical cross-sectional view of milling unit 300X in the comparative example.

As shown in FIG. 27, milling unit 300X in the comparative example is different from milling unit 300 according to the first embodiment in including a rib 325X in cylindrical portion 322 of hopper 320 but substantially the same in other features.

Rib 325X is provided to protrude from the inner circumferential surface of hopper 320 toward core 355. Rib 325X is provided to extend along the direction of the axial line of cylindrical portion 322 from an upper end to a lower end on the inner circumferential surface of cylindrical portion 322. Rib 325X is substantially equal to or smaller than core 355 in width in a direction orthogonal to the direction of the axial line of cylindrical portion 322.

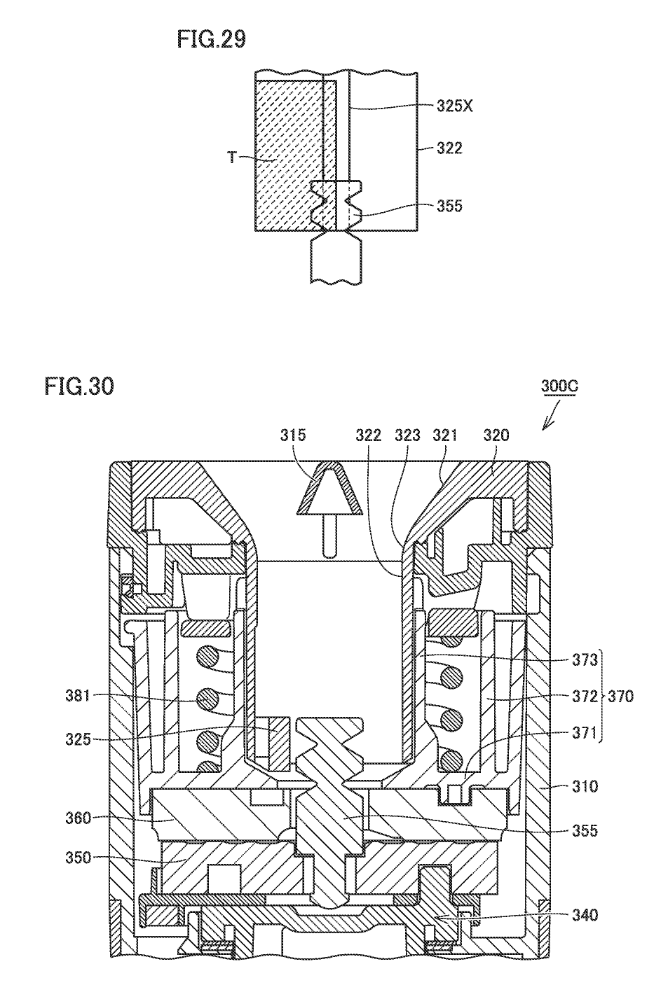

Tea leaves in the hopper in grating of tea leaves with milling unit 300X in the comparative example will be described with reference to FIGS. 28 and 29. FIG. 28 is a view from above of tea leaves in the hopper in grating tea leaves with the milling unit in the comparative example. FIG. 29 is a cross-sectional view along the line XXIX-XXIX shown in FIG. 28.

As shown in FIGS. 28 and 29, when tea leaves are introduced into hopper 320 with milling unit 300X in the comparative example, relatively long tea leaves T1 and T2 are caught between rib 325X and core 355 and tea leaves may be retained on a rear side of rotation relative to rib 325X.

Since rib 325X is provided to extend along the direction of the axial line of cylindrical portion 322 from the upper end to the lower end on the inner circumferential surface of cylindrical portion 322, tea leaves are caught sequentially from below along rib 325X. Thus, tea leaves T are retained in the entire direction of height of cylindrical portion 322.

As core 355 rotates, tea leaves are collected to one side (the left side in FIG. 29) in cylindrical portion 322 and tea leaves are significantly small in amount on the other side (the right side in FIG. 29) in cylindrical portion 322.

Therefore, tea leaves are not pulled in between upper mill 360 and lower mill 350 in general, and an amount of production of tea leaf powders becomes unstable. Since tea leaves are retained on one side without tea leaves in cylindrical portion 322 uniformly decreasing, whether or not tea leaves are pulled in between upper mill 360 and lower mill 350 cannot visually be checked either.

### Fourth Embodiment

(Milling Unit 300C)

A milling unit 300C according to the present embodiment will be described with reference to FIG. 30. FIG. 30 is a partial vertical cross-sectional view of milling unit 300C according to the present embodiment.

Milling unit 300C shown in FIG. 30 is different from milling unit 300X in the comparative example in height of rib 325 but substantially the same in other features. An upper end of rib 325 is located at a height not higher than the upper end of core 355 located in hopper 320.

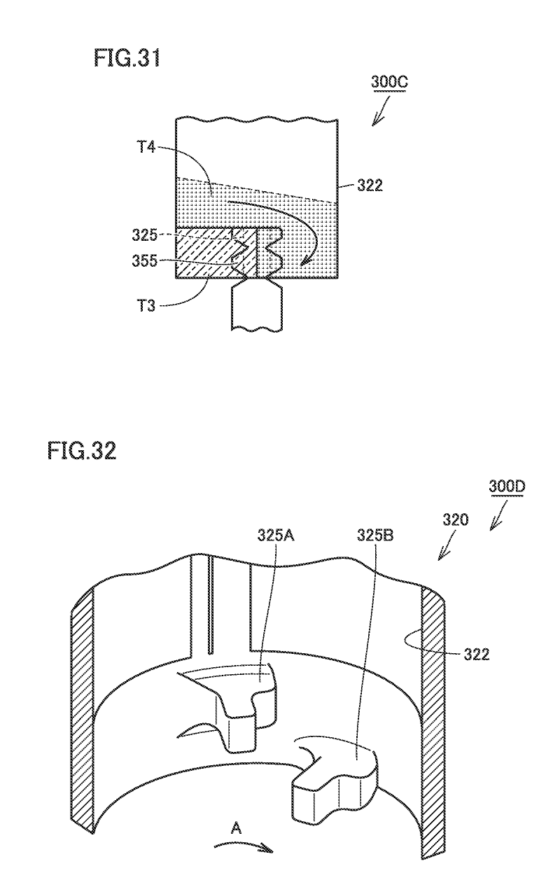

Tea leaves in hopper 320 in grating of tea leaves with milling unit 300C according to the present embodiment will be described with reference to FIG. 31. FIG. 31 is a cross-sectional view showing tea leaves in the hopper in grating tea leaves with the milling unit according to the present embodiment.

As shown in FIG. 31, a position of the upper end of rib 325 is not higher than the upper end of core 355. A sufficiently wide space is provided above rib 325, and even movement of relatively long tea leaves will not be prevented.

Even when tea leaves are caught between rib 325 and core 355 and some tea leaves T3 are retained on one side in cylindrical portion 322, other tea leaves can ride over some retained tea leaves. Tea leaves T4 which have ridden over the retained tea leaves are tilted toward the other side in cylindrical portion 322 in which an amount of tea leaves has decreased as shown with an arrow in the figure.

Since such movement of tea leaves is continuously repeated during milling, tea leaves are agitated above core 355. Thus, tea leaves can smoothly be pulled in between upper mill 360 and lower mill 350 in a stable manner. Consequently, powder tea leaves can be produced in a stable manner.

Since tea leaves are agitated above core 355, an amount of tea leaves decreases in general in hopper 320 and tea leaves being pulled in between upper mill 360 and lower mill 350 in a stable manner can also visually be checked.

### Fifth Embodiment

(Milling Unit 300D)

A milling unit 300D according to the present embodiment will be described with reference to FIG. 32. FIG. 32 is a diagram showing the inside of the hopper in milling unit 300D according to the present embodiment.

As shown in FIG. 32, milling unit 300D according to the present embodiment is different from milling unit 300C according to the fourth embodiment in including a plurality of ribs 325A and 325B but substantially the same in other features.

The plurality of ribs 325A and 325B are provided on the inner circumferential surface of hopper 320 at an interval along the circumferential direction. The plurality of ribs 325A and 325B are provided as being displaced in the vertical direction sequentially downward from above along the direction of rotation (arrow A in the figure) of core 355 with the rib located highest being defined as the reference.

An upper end of rib 325A is located at a height not higher than the upper end of core 355. An upper end of rib 325B is located below a lower end of rib 325A. Rib 325B is preferably located below rib 325A. Rib 325B is located on the front side in the direction of rotation of core 355 relative to rib 325A. A height of each of ribs 325A and 325B along the direction of the axial line of cylindrical portion 322 is preferably not greater than pitch P of helical blade 355a of core 355.

Ribs 325A and 325B are thin at a tip end portion and thick at a root portion, and the root portion on the front side in the direction of rotation is thick. By making the tip end portion as thin as possible, pull-in of tea leaves can be prevented from being blocked. By making the root portion as thick as possible, strength is ensured.

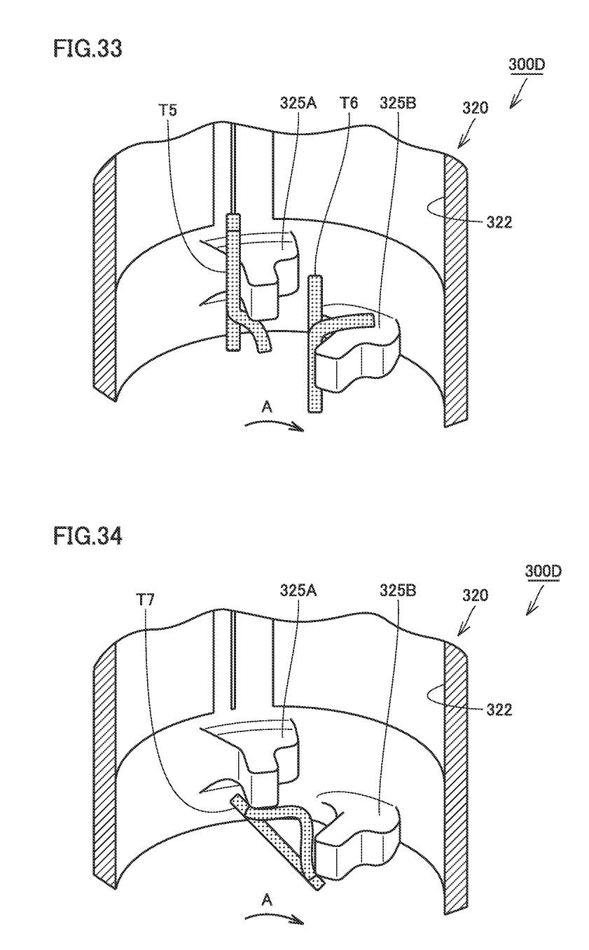

Tea leaves sheared in the hopper will be described with reference to FIGS. 33 and 34. FIGS. 33 and 34 are diagrams showing one example and another example of tea leaves sheared in the hopper shown in FIG. 32, respectively.

As shown in FIG. 33, when relatively long tea leaves T5 and T6 are caught by ribs 325A and 325B, shear force is applied to tea leaves T5 and T6 caught by ribs 325A and 325B as core 355 rotates. Thus, tea leaves are sheared to be finer and are smoothly pulled in between upper mill 360 and lower mill 350.

As one end side of tea leaves abuts on ribs 325A and 325B, tea leaves are inclined and are more likely to be introduced in a pitch of helical blade 355a of core 355. Tea leaves are also thus smoothly pulled in between upper mill 360 and lower mill 350.

As shown in FIG. 34, ribs 325A and 325B are provided as being displaced in the vertical direction sequentially downward from above along the direction of rotation of core 355 with rib 325A located highest being defined as the reference, so that the lower end side of tea leaves T7 can also be caught by rib 325B while the upper end side of tea leaves T7 is caught by rib 325A.

In such a case, by applying shear force to the central portion of tea leaves T7, tea leaves T7 can efficiently be sheared. By shearing tea leaves to a size allowing easy intake into core 355, tea leaves can smoothly be pulled in between upper mill 360 and lower mill 350.

By providing the plurality of ribs 325A and 325B at an interval in the direction of rotation, load imposed on core 355 can be distributed as compared with an example in which a plurality of ribs are aligned along a direction in parallel to the direction of the axial line of cylindrical portion 322. Thus, core 355 can be prevented from being broken.

Though an example in which a core having a notch portion as an engagement portion has been described in the present embodiment substantially as in the first embodiment by way of example, limitation thereto is not intended and a core without an engagement portion such as a notch or a projecting portion may be employed.

When a core provided with an engagement portion is employed, rotational force of core 355 is transmitted not only from the peripheral end surface of helical blade 355a but also from the engagement portion engaged with tea leaves and hence shear force can more effectively be applied to tea leaves. When an engagement portion includes a projecting portion, the engagement portion is preferably provided between the plurality of ribs 325A and 325B in the vertical direction. Providing the engagement portion between the plurality of ribs 325A and 325B means that the engagement portion is provided to be able to pass between the plurality of ribs 325A and 325B in the vertical direction while the core rotates.

Though an example in which two ribs are provided as a plurality of ribs has been described in the present embodiment by way of example, limitation thereto is not intended and three or more ribs may be provided so long as an upper end of the rib located highest is located at a height not higher than the upper end of core 355.

Though an example in which a plurality of notch portions are provided in first helical blade portion 355a1 and second helical blade portion 355a2 has been described in the first to third embodiments described above by way of example, limitation thereto is not intended and a single notch portion may be provided.

Though an example in which core 355 includes helical blade 355a has been described in the first to third embodiments described above by way of example, limitation of a shape of helical blade 355a is not intended, and core 355 should only include a plate-shaped portion provided to intersect with the direction of the axial line of core 355 so long as tea leaves can be guided to opening portion 361 in upper mill 360 while tea leaves are stirred as a result of rotation. In such a case, the above-described engagement portion engaged with tea leaves is provided in the peripheral end surface of the plate-shaped portion, so that an effect substantially the same as in the first to third embodiments is obtained.

Though the embodiments of the present invention have been described above, the embodiments disclosed herein are illustrative and non-restrictive in every respect. The scope of the present invention is defined by the terms of the claims and is intended to include any modifications within the scope and meaning equivalent to the terms of the claims.

### REFERENCE SIGNS LIST

1 beverage preparation apparatus; 100 apparatus main body; 110 control portion; 120 milling motor unit; 130 milling driving force coupling mechanism; 140 agitation motor unit; 140A agitation motor contactless table; 141 permanent magnet; 150 hot water supply pipe; 155 liquid supply path; 160 heater; 170 hot water supply nozzle; 171 supply port; 180 milling unit attachment portion; 190 agitation tank attachment portion; 195 liquid storage tank attachment portion; 300, 300A, 300C, 300D, 300X milling unit; 300W window for coupling; 310b upper end opening portion; 310 milling case; 311 storage portion; 312 discharge path; 312a discharge outlet; 315 safety rib; 320 hopper; 321 diameter-increasing portion; 322 cylindrical portion; 323 opening portion; 325, 325A, 325B, 325X rib; 330 cover portion; 340 lower mill support portion; 341 main body portion; 342 engagement protrusion portion; 343 powder scraping portion; 345 milling shaft; 350 lower mill; 350a lower mill grinding surface; 350b main surface; 350c circumferential surface; 351 grating groove; 352 engagement recess portion; 353 through hole; 355, 355A, 355B core; 355a1 first helical blade portion; 355a2 second helical blade portion; 355a helical blade; 355b tab portion; 355c reinforcement rib; 355d base portion; 355e shaft portion; 355f upper surface; 356, 357 notch portion; 356a, 357a end surface; 358 protrusion portion; 358a end surface; 360 upper mill; 360a upper mill grinding surface; 360b main surface; 360c circumferential surface; 361 opening portion; 362 hole portion; 370 upper mill holding member; 371 bottom surface portion; 371a hole portion; 372 outer cylindrical portion; 373 inner cylindrical portion; 380 spring holding member; 381 spring; 500 agitation unit; 510 agitation tank; 511 exterior holder; 512 thermally insulated tank; 513 opening portion; 520 grip; 530 agitation cover; 531 powder inlet; 532 hot water supply inlet; 540 discharge port opening and closing mechanism; 541 discharge port; 542 operation lever; 543 opening and closing nozzle; 545 discharge portion; 550 agitation blade; 551 cylindrical core; 552 permanent magnet; 560 rotation shaft; 700 liquid storage tank; 710 tank main body; 720 lid portion; 800 tea leaf powder tray; and 900 placement base.

1-9. (canceled)

10. A grating apparatus grating an object to be grated comprising:
an upper mill including an upper mill grinding surface and an opening portion in a center of the upper mill grinding surface;
a lower mill located below the upper mill and including a lower mill grinding surface abutting on the upper mill grinding surface; and
a core at least partially located in the opening portion,
the core including a plate-shaped portion which rotates, and
an engagement portion engaged with the object to be grated being provided in a peripheral end surface of the plate-shaped portion.

11. The grating apparatus according to claim 10, wherein
the engagement portion includes a notch portion provided in the peripheral end surface of the plate-shaped portion.

12. The grating apparatus according to claim 11, wherein
the notch portion has an end surface intersecting with a tangent line at a contact point portion provided in a periphery of the plate-shaped portion and is in a shape opening forward in a direction of rotation when viewed from the end surface.

13. The grating apparatus according to claim 10, wherein
the engagement portion includes a projecting portion provided to project radially outward from the peripheral end surface of the plate-shaped portion.

14. A beverage preparation apparatus comprising:
the grating apparatus according to claim 10;
a tank storing a liquid; and
an agitation tank to which powders obtained by the grating apparatus and the liquid are supplied and in which the powders and the liquid are mixed.

15. A grating apparatus grating an object to be grated comprising:
a cylindrical hopper in which the object to be grated is introduced;
an upper mill located below the hopper and including an upper mill grinding surface and an opening portion in a center of the upper mill grinding surface;
a lower mill located below the upper mill and including a lower mill grinding surface abutting on the upper mill grinding surface; and
a core at least partially located in the opening portion,
the hopper including a rib projecting from an inner circumferential surface toward the core, and
the rib having an upper end located at a height not higher than an upper end of the core located in the hopper.

16. The grating apparatus according to claim 15, wherein
a plurality of the ribs are provided, and
the plurality of ribs are provided at an interval along a circumferential direction as being displaced in a vertical direction.

17. The grating apparatus according to claim 15, wherein
the core includes a plate-shaped portion which rotates, and
an engagement portion engaged with the object to be grated is provided in a peripheral end surface of the plate-shaped portion.

18. The grating apparatus according to claim 17, wherein
the engagement portion is provided between the plurality of ribs in a vertical direction.

19. A beverage preparation apparatus comprising:
the grating apparatus according to claim 15;
a tank storing a liquid; and
an agitation tank to which powders obtained by the grating apparatus and the liquid are supplied and in which the powders and the liquid are mixed.
